(19) United States
(12) Patent Application Publication
(10) Pub. No.: US 2008/0052412 A1
(43) Pub. Date: Feb. 28, 2008

(54) DISTRIBUTED PORTEL SYSTEM, CONTENT PAGE CREATION SERVER AND RECORDING MEDIUM

(76) Inventors: Naoya MAEDA, Tokyo (JP); Shinsuke INOUE, Tokyo (JP); JIRIMUTO, Chiba (JP)

Correspondence Address: WILLIAM COLLARD;COLLARD & ROE, P.C., 1077 NORTHERN BOULEVARD, ROSLYN, NY, 11576, US

(21) Appl. No.: 11/467,144

(22) Filed: Aug. 24, 2006

(51) Int. Cl. G06F 15/16; G06F 3/00

(52) U.S. Cl. 709/246; 715/700; 709/203

(57) ABSTRACT

A distributed portal system 20 is used for designing and managing the creation and management of website content pages at two or more sites and comprises a main Web server 21 and one or more part execution servers 22, 23. The main Web server is connected to the part execution servers by the Internet and comprises a content management system for managing a content page by dividing the content page into an arbitrary plurality of areas, disposing content separately in each of the areas, and managing the content that is disposed in the areas by separating the content into a plurality of blocks and disposing HTML text or parts in each of the blocks. The part execution server comprises a part database for storing parts, and has functions for entering and retrieving required parts from the part database in response to external requests and for executing parts.

### TECHNICAL FIELD

The present invention relates to a distributed portal system, a content creation server and a recording medium suitable for realizing a content management system for designing and managing Web pages over the Internet.

### BACKGROUND ART

Conventionally, the creation of content pages which are provided from a Web server, and more specifically content management systems for designing and managing Web pages, are such that the Web pages are created on a single Web server. A creator, who creates Web pages, stores programs and data for producing content pages in the file system or the memory of one Web server.

JP-2004-046819-A describes one example of conventional technology relating to content pages on a Web server.

A problem to be solved by the present invention is that of adding to a website a content management system for creating and managing content pages that are provided for this same website, so as to constitute a divided or distributed portal site system that uses one or more other servers at different sites.

Thus, an object of the present invention is to provide a distributed portal system and a content page creation server, capable of realizing a content management system for designing and managing the creation and management of content pages on one website, using servers at two or more sites that are connected via the Internet.

Furthermore, another object of the present invention is to provide a recording medium that stores a program for the distributed portal system and the content page creation server, so as to constitute the content management system described above.

### DISCLOSURE OF THE INVENTION

In order to achieve the objects recited above, the distributed portal system, content page creation server and recording medium according to the present invention have the following constitutions.

A first distributed portal system (corresponding to claim 1) comprises a content page creation server and one or more part execution servers. The content creation server and the one or more part execution servers are connected via the Internet or the like. The content page creation server has a content management system for managing at least one content page that is provided from one website by dividing the content page into an arbitrary plurality of areas, disposing content separately in each of the plurality of areas in the content page, and further managing the content that is disposed in the areas by dividing the content into a plurality of blocks and disposing HTML text content or parts in the plurality of blocks. Each of the part execution servers comprise a part content database for storing part content, for entering and retrieving required the part content from the part content database in response to external requests and for executing the parts. The content page creation server comprises means for issuing part retrieval requests to the part execution server and retrieving content text for parts from the part execution servers by way of an Internet communication protocol.

A second distributed portal system (corresponding to claim 2) is such that, in the constitution described above, the one or more part execution servers are preferably disposed in a distributed spatial relationship with respect to the content page creation server, and the content page creation server and the one or more part execution servers are connected so as to allow for Internet communication.

A third distributed portal system (corresponding to claim 3) is such that, in the constitution described above, control and management functions for creating content pages by way of the content management system on the content page creation server preferably operate on the basis of requests from a Web browser on an end-user terminal device that is connected so as to allow for communication via the Internet.

A forth distributed portal system (corresponding to claim 4) is such that, in the constitution described above, the part execution server preferably comprises access authorization means for determining whether or not the requests from the content page creation server will be received.

A fifth distributed portal system (corresponding to claim 5) is such that, in the constitution described above, the content page creation server preferably includes the part execution server.

A sixth distributed portal system (corresponding to claim 6) is such that, in the constitution described above, the parts are preferably Web programs for sending HTML text content by way of an Internet communication protocol.

A seventh distributed portal system (corresponding to claim 7) is such that, in the constitution described above, the Internet communication protocol is preferably the HTTP protocol.

A first content page creation server (corresponding to claim 8) comprises a content management system, a part database, part execution means, and means for retrieving content. The content management system has functions for managing at least one content page that is provided from one web site by dividing the content page into an arbitrary plurality of areas, disposing content separately in each of the plurality of areas in the content page, and further managing the content that is disposed in the areas by dividing the content into a plurality of blocks and disposing HTML text content or parts in the plurality of blocks. The part content database stores part content. The part execution means has functions for entering and retrieving required the part content from the part content database in response to requests, and for executing the parts. The means for retrieving content issues part retrieval requests to the part execution means and retrieves content text for parts from the part database by way of an Internet communication protocol.

A second content creation server (corresponding to claim 9) is such that, in the constitution described above, the parts are preferably Web programs for sending HTML text content by way of an Internet communication protocol.

A third content creation server (corresponding to claim 10) is such that, in the constitution described above, the Internet communication protocol is preferably the HTTP protocol.

Another aspect of the present invention is a computer readable recording medium (corresponding to claim 11) storing a program that causes one or more computers to be operated as the various means that constitute the distributed portal system described above. Yet another aspect of the present invention is a computer readable recording medium (corresponding to claim 12) storing a program that causes a computer to be operated as the various means that constitute the content creation server described above.

By virtue of the distributed portal system or content page creation server of the present invention, it is possible to realize a content management system for designing and managing the creation and management of a website at a single location by way of servers at two or more sites that are connected via the Internet.

### BRIEF DESCRIPTION OF THE DRAWINGS

FIG. 1 shows one example of page content that is created by a Web server at a web site and stored in, and provided from, the memory unit of the web server.

FIG. 2 is a system structure diagram showing the overall constitution of one mode of embodiment of the distributed portal system according to the present invention.

FIG. 3 is a flow chart showing a representative working example using the core engine that is executed on the main Web server of the distributed portal system according to this mode of embodiment.

FIG. 4 is a flow chart showing a representative operation example using the part running engine that is executed on the main Web server of the distributed portal system according to this mode of embodiment.

### BEST MODE FOR CARRYING OUT THE INVENTION

Hereinbelow, a preferred mode of the embodiment (working example) of the present invention is described with reference to the appended drawings.

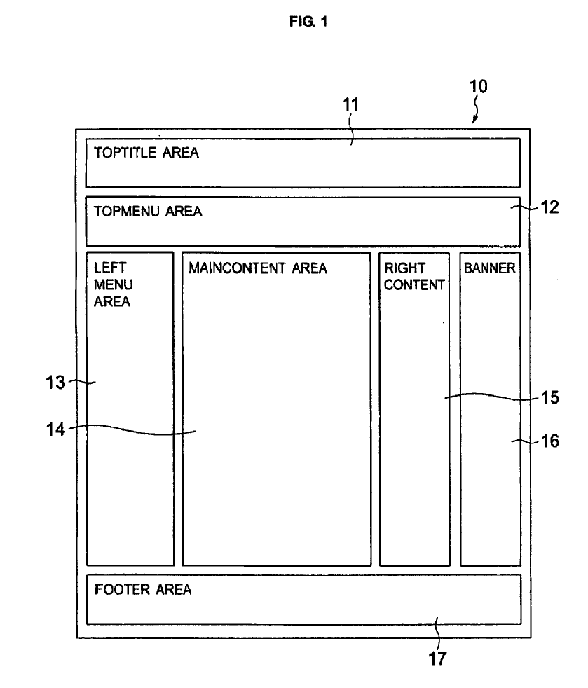

One mode of embodiment for the distributed portal system according to the present invention is described with reference to FIGS. 1 to 4.

FIG. 1 shows one example of page content, which is created by one Web server at any website, and which is stored in, and provided form, the memory unit of the Web server at this website. The page content shown here is the first page of content provided by the website. One content page 10 is divided into, for example, seven rectangular areas. Area 11 is a top title area; area 12 is a top menu area; area 13 is a left menu area; area 14 is a main content area; area 15 is a right column area; area 16 is a banner area; and area 17 is a footer area.

Content comprising “HTML text” and the “parts” described below are disposed in these areas 11 to 17.

The completed content page 10 is a first page of content, which can, for example, be seen on the screens of display devices belonging to one or more arbitrary users (end-users) or which allows for processing such as content page creation, when the user calls up content from that web server by accessing a website over the Internet with the browser software on their terminal, by entering a predetermined URL. Other content pages, from the second page onwards, are likewise divided into a plurality of rectangular areas. FIG. 1 shows the content page 10, which is the first page, and the pages from the second page onwards are not illustrated.

The content in the areas 11 to 17 of the content page 10 are displayed on the screen of the terminal display device. The dimensions of the areas for displaying the content can be expanded or contracted to suit the content.

The programs and data (text data, image data, various types of operational data and the like) for producing the content page 10 are unified in terms of the design, creation, storage and management of the single content page 10. However, the constitution is such that when these are created, or when these are stored and managed, they are created stored and managed as seven separate areas 11 to 17.

With the distributed portal system (or content page creation server) according to the present mode of embodiment, each content page is designed by dividing it into a plurality of rectangular areas which are created, stored and managed separately, as shown in content page 10 above.

With the distributed portal system according to the present mode of embodiment, the areas 11 to 17 that constitute the content page 10 may each be separately stored and managed, not only on the aforementioned main Web server on which the content is created, but also on one or more other servers that are connected via the Internet to this main Web server, on the basis of a linking relationship therebetween, while the creation operations are performed on the main Web server.

As described above, the content that is displayed in the content page 10 is managed by dividing it into area blocks 11 to 17. These display content area blocks 11 to 17 will be referred to as “components 11 to 17”. The content of the components 11 to 17 comprises static “HTML text” or “parts.” The components 11 to 17 are stored in a single table which is managed by sorting related areas according to kind. Static “HTML text” or “parts” are disposed in the components 11 to 17. The content is normally static HTML text.

Here, the term “part” refers to a Web program for supplying specific dynamic content. This is a program that sends HTML text content in accordance with an Internet transmission protocol such as the HTTP protocol. The “parts” that are used in the present system may be specially created for the system or may make use of various functions from certain existing Web applications.

The distributed portal system according to the present mode of embodiment comprises a content management system that allows for the creation, storage and management of content pages as described above.

The computer system according to this distributed portal system comprises one main Web server and one or more other servers that are connected thereto via the Internet. In this distributed portal system, the main Web server constitutes a content creation server or has this function. A program for realizing the functions of the content management system is provided in a memory unit, and the server further comprises a database for storing parts. The main Web server is a server for generating pages in which parts are disposed. Meanwhile, the one or more other servers are computers for storing and managing the various types of part content, and for executing the parts (hereinafter referred to as “part execution servers”). In this distributed portal system, the content management system that is provided on the main Web server not only runs on this Web server, but also accesses other servers via the Internet so as to select and execute parts.

When the content management system creates a content page, the content management system retrieves and executes parts that are stored in the part storage database that is provided in the content page creation server on the basis of the creation of procedures described below and suitably generates or retrieves HTML text so as to produce a content page in the page creation area.

In this distributed portal system, the content management system that is provided on the main Web server can execute parts on the main Web server by transferring/transmitting parts or the like by protocol such as HTTP, and can also execute these on other servers. These “parts” can be completely separated from the Web server that constitutes the basic system so as to realize a completely distributed portal system. “Parts” that are executed by distributed servers can be disposed in the components of the system according to the present mode of embodiment. Thus, the distributed portal system according to the present mode of embodiment is such that the parts that are disposed in the components 11 to 17 of the content page 10 can be executed on servers other than the main Web server.

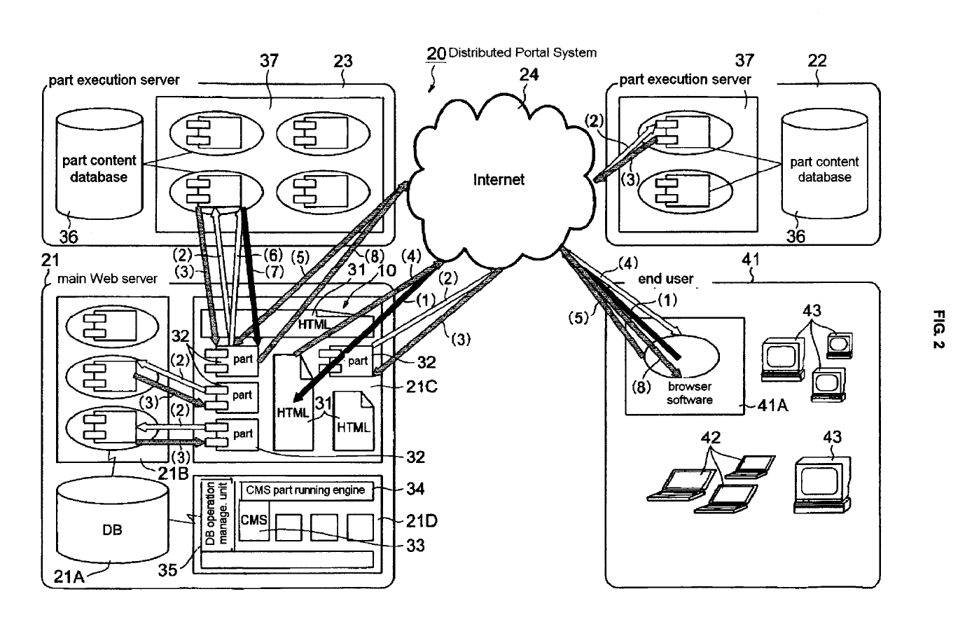

Next, the structure of the aforementioned distributed portal system and the method by which the content page 10 illustrated in FIG. 1 is created are described with reference to FIG. 2 to FIG. 4.

In FIG. 2, a distributed portal system 20 comprises one main Web server 21 (hereinafter referred to as the “main Web server”) and, for example, two part execution servers 22, 23. The main Web server 21 and the part execution server 22 are connected via the Internet 24 and are capable of transmitting and receiving data and programs. The main Web server 21 and the part execution server 23 are connected directly, without passing through the Internet 24, so as to be able to transmit and receive data and programs. The two part execution servers are selected according to the type of parts developed.

The main Web server 21 comprises a database (DB) 21A for storing HTML text or parts, which are the content that is disposed in the components 11 to 17 of the content page 10; a part execution unit 21B for executing parts that are retrieved from the database 21A; a part disposition page (page creation area) 21C in which the components 11 to 17 are separately built in the content page 10; and a control unit 21D for controlling the database 21A, the part execution unit 21B and the part disposition page 21C, so as to create the content page 10 and the like.

The content page 10 in the page creation area 21C shown in FIG. 2 is illustrated, by way of example, as comprising three sets of HTML text 31 and four parts 32, which are disposed in the components 11 to 17. The control unit 21D comprises a content management system (CMS) 33, a CMS part running engine 34, and a DB operation management unit 35. The core engine of the distributed portal system 20 according to the present mode of embodiment is realized and executed on the basis of the content management system 33, the CMS part running engine 34 and the like of the control unit 21D, as described below.

The part execution servers 22, 23 comprise a part content database 36 for storing part content and a part execution unit 37 for executing parts.

In the distributed portal system 20, end-users 41 are shown for this main Web server 21 and the part execution servers 22, 23. A plurality of notebook computers 42 and workstations 43 are shown as the Internet terminals for the end-users 41. The users (end-users) who use the Internet terminals (42, 43) access the Web server 21 and the like by way of browser software 41A on these Internet terminals.

The distributed portal system 21 illustrated in FIG. 2 has a structure that creates a relationship between three entities: a part user, a part supplier and an end-user 41.

The part user follows a predetermined procedure so as to use the main Web server 21 to design the part disposition page 21C on the main Web server 21, and publish this on the Internet.

The part supplier uses the part execution servers 22, 23 to allow parts to be used by following a predetermined procedure so as to log in to the main Web server 21 and register parts (part content) that they have developed by themselves in the distributed portal system 20 to be used.

The end-user 41 can access the part disposition page 21C on the main Web server 21. When the end-user 41 accesses the part disposition page 21C, the core engine on the main Web server 21 operates so as to display response HTML on the screen of the display device of the Internet terminal of the end-user 41.

The structure of the distributed portal system 20 illustrated in FIG. 2 is such that the following eight content access steps (1) to (8), which is to say steps for sending and receiving instructions (commands), messages, data (programs) and the like, are executed between the main Web server 21, the part execution servers 22, 23 and the end-user 41.

### Step (1):

A request is issued from the browser software 41A to the part disposition page 21C of the main Web server 21.

### Step (2):

The content management system 33 on the main Web server 21 receives the request and issues a request to the part execution servers 22, 23 or the part execution unit 21B.

### Step (3):

A response (HTML, part) is returned from the part execution servers 22, 23 or the like.

### Step (4):

The content management system 33 merges the HTML for the parts and the HTML that is stored in the database 21A according to a template layout and returns it to the end-user 41, which is to say, to the client.

### Step (5):

When a POST request for a part is issued from the browser software 41A, a POST request is issued for the page in the content management system 33.

### Step (6):

After the content management system 33 has received the POST request, a decision is made as to which part the POST request concerns, whereupon the POST request is forwarded to the part execution server 23 or the like.

### Step (7):

The part execution server 23 or the like receives the POST request, completes the work that is requested and returns a response to the content management system 33.

### Step (8):

The content management system 33 receives the response from the part server 23 or the like, merges this with the page cache, and returns a response.

As described above, the distributed portal system 20 according to the present mode of embodiment is a content creation system that is designed so as to dispose parts in the content page 10, so as to create the content page 10. Thus, as described above, the part supplier who supplies the part, the part user that uses the part to supply content, and the Internet end-user 41 who accesses the content are participants.

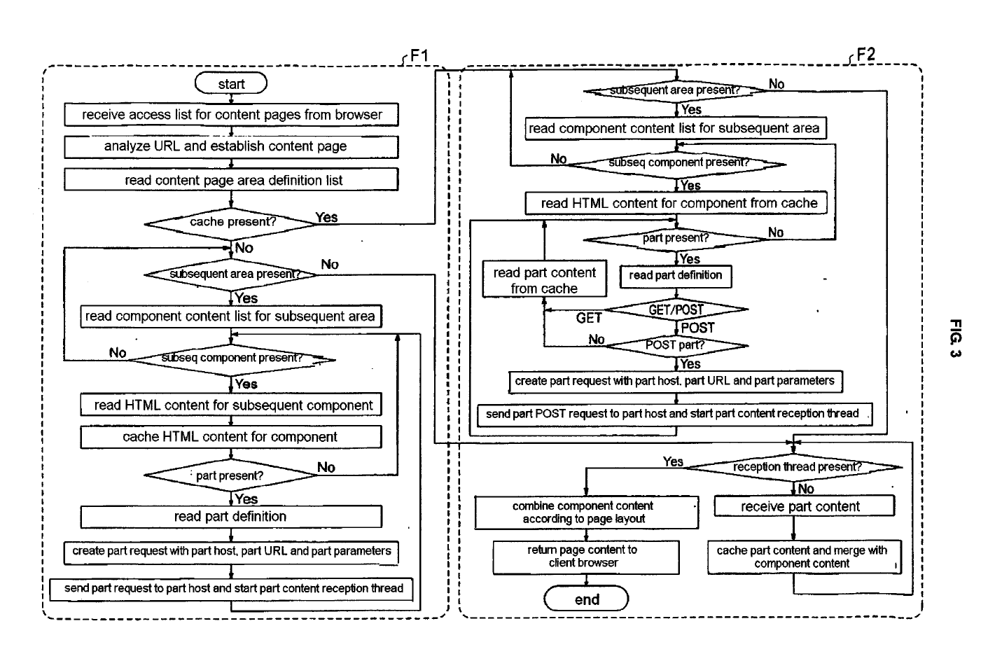

Next, a representative example of operation using the core engine that is executed on the main Web server 21 in the distributed portal system 20 is described with reference to FIG. 3. Note that working examples for the core engine are not limited to that described herein.

The flowchart for the core engine that is shown in FIG. 3 is divided into two blocks, F1 and F2.

First, in block F1, access is made from the browser software 41A of the end-user 41 to the content page 10 on the main Web server 21 (step S11). When this access is received, the request URL is determined from the access, the content page 10 is established, and the setting information for the content page 10 is read (step S12). Next, the content page area definition list (component type list) is read (step S13). In a further decision step S14, a decision is made as to whether or not a cache exists for this content page 10.

If a cache exists (if Yes) in the decision step S14, the program proceeds to step S31 in block F2, and if No the program proceeds to the next decision step S15.

In decision step S15, because a cache does not exist, as long as there is a subsequent area (if Yes) and given that there is no subsequent component (step S17), the processing in step S16 is repeatedly executed for each area until all of the areas have been completed. When all of the areas have been completed (when No) the program advances to step S42 in block F2. Next, in the step S16, the component content list for the next area is read.

In decision step S17, if a subsequent component is present, the processing in the subsequent steps S18 and S19 is cycled for each component until all of the components have been completed. Next, in step S18, the HTML content for the next component is read. Then, in step S19, the HTML component is cached. When component processing has completed, the program returns to step S16 and the subsequent processing is performed.

In decision step S20, a decision is made as to whether a part has been assigned to the component.

If a part has not been assigned to the component, the program returns to step S17 and the next component is processed. If a part has been assigned to the component, the program reads the definition of the part that has been assigned (step S21).

Thereafter, at step S22, the part execution server (part server), the URL for accessing the part, and the parameters necessary to access the part are extracted from the part settings and an HTTP request to be sent to the part execution server is built. Subsequently, at step S23, the HTTP request is sent to the part execution server (22, 23) or the like and a standby thread is started for reception of the part response.

After executing step S23, the program returns to step S17, whereafter the next component is processed.

Next, the operations in block F2 are described. Block F2 is a flowchart illustrating operations when a cache is present.

In the first step S31, a decision is made as to whether or not a subsequent area is present. If the decision step S31 is evaluated as No, the program advances to step S42, and if this is evaluated as Yes, the next step S32 is executed.

Next, in step S32, the component content list for the next area is read. Thereafter in decision step S33, if it is judged that a subsequent component is not present, the processing in the subsequent steps S31, S32 is repeated, and this is cycled for each component until all of the components have been completed, so long as the decision step S33 is evaluated as No. When the decision step S33 is evaluated as Yes, the program advances to step S34. Next, in step S34, the HTML content for the next component is read from the cache.

Thereafter, in the subsequent decision step S35, a decision is made as to whether a part has been assigned to the component. If a part has not been assigned to the component, the program returns to step S33 and the next component is processed. If a part has been assigned to the component, the program reads the part settings (step S36).

After step S36, a decision is made as to whether the request is a GET request or a POST request (step S37). If the request is a GET request, the program moves to step S41. If the request is a POST request, the program advances to step S38, and at this step S38 a decision is made as to whether or not the part type is POST. In decision step S38, if the part type is not POST, the program moves to step S41, and if the part type is POST, the program advances to the subsequent step S39.

Next, in step S41, the part content for the component is read from the cache. Subsequently, the program returns to step S35.

Thereafter at step S39, the part execution server (part server), the URL for accessing the part, and the parameters necessary to access the part are extracted from the part settings for the POST part, and an HTTP request to be sent to the part execution server is built. Subsequently, at step S40, the HTTP request is sent to the part execution server (22, 23) or the like and a standby thread is started for reception of the part response.

After executing step S40, the program returns to step S35, whereafter the next component is processed.

Next, in step S42, a decision is made as to whether a standby thread is present. If a standby thread is present (Yes), steps S43 and S44 are repeatedly executed. In step S43, the program stands by for the content and then in step S44, the response content for the part is cached, and then merged with the component content.

In decision step S42, if the end is reached without a standby thread (No), the component contents are combined in accordance with the page layout (step S45) and this page content is returned to the browser software 41A of the end-user 41 (step S46). Thereafter, the core engine program terminates.

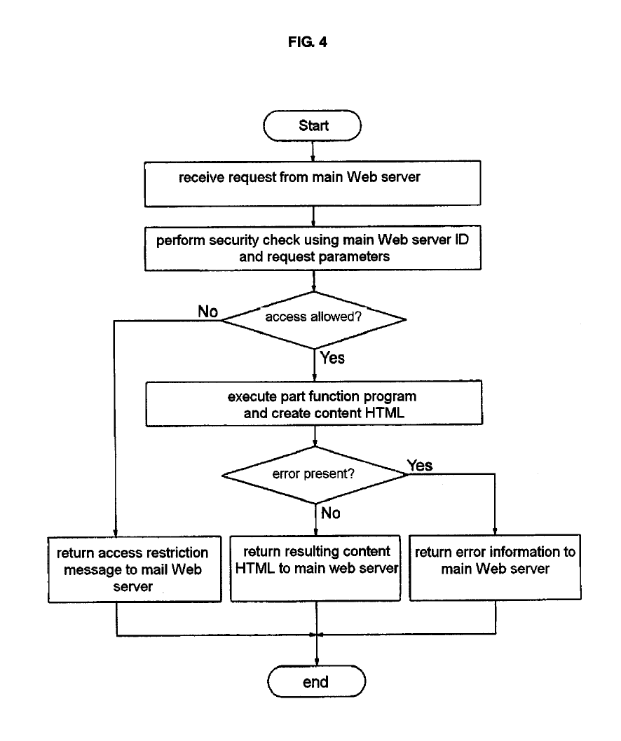

Next, a representative example of operation by way of the part running engine 34 that is executed on the main Web server 21 in the distributed portal system 20 is described with reference to FIG. 4. With the constitution of the distributed portal system 20 according to the present mode of embodiment, operation of the parts is greatly simplified.

First, a request is received from the main Web server 21 by the part execution servers 22, 23 (or part execution unit 21B) (step S51). Next, in step S52, a security check is performed on the basis of the system ID and the request parameters contained in the request. As a result of this security check, a decision is made as to whether or not access can be allowed (step S53). If the decision step is evaluated as Yes, the program advances to step S54, and if the decision step is evaluated as No, the program advances to step S57.

If access is denied, and access restriction message is returned to the main Web server 21 (steps S57), whereafter the program terminates. If access is allowed, a part function program is executed so as to produce the content HTML (step S54) and the program subsequently advances to the decision step S55.

In the decision step S55, a decision is made as to whether or not a processing error has occurred. If a processing error has occurred, the error information is returned to the main Web server 21 (step S58). If a processing error has not occurred, the resulting content HTML is returned to the main Web server 21. Thereafter, the program terminates.

Another embodiment of the present invention is such that, while this is a single stand-alone content page creation server, in so much as parts are managed by disposing them in components, the constitution within the content page creation server is the same constitution as the distributed portal system described above.

A program for realizing the content management system functions described above, as well as the core engine and the part running engine described above can be provided in the memory unit of the content page creation server. When the content management system creates a content page, the content management system retrieves and executes parts that are stored in the part storage database that is provided in the content page creation server, on the basis of the creation procedures described above, and suitably generates or retrieves HTML text so as to produce content pages in the part disposition page.

The modes of embodiment described above are provided merely to facilitate understanding and reduction to practice of the present invention. Accordingly, the present invention is not limited to the modes of embodiment described, and various modifications can be made without exceeding the scope of the technical ideas set forth in the claims.

### INDUSTRIAL APPLICABILITY

The distributed portal system according to the present invention can be used as a content management system for designing and managing web pages directly over the Internet.

1. A distributed portal system comprising:
a content page creation server having a content management system for managing at least one content page that is provided from one website by dividing said content page into an arbitrary plurality of areas, disposing content separately in each of said plurality of areas in said content page, and further managing said content that is disposed in said areas by dividing said content into a plurality of blocks and disposing HTML text content or parts in said plurality of blocks; and
one or more part execution servers, which each comprise a part content database for storing part content, for entering and retrieving required part content from said part content database in response to external requests and for executing said parts; and
said content page creation server comprising means for issuing part retrieval requests to said part execution server and retrieving content text for parts from said part execution servers by way of an Internet communication protocol.

2. The distributed portal system recited in claim 1, wherein said one or more part execution servers are disposed in a distributed spatial relationship with respect to said content page creation server and said content page creation server, and said one or more part execution servers are connected so as to allow for Internet communication.

3. The distributed portal system recited in claim 1, wherein control and management functions for creating content pages by way of said content management system on said content page creation server operate on the basis of requests from a Web browser on an end-user terminal device that is connected so as to allow for communication via the Internet.

4. The distributed portal system recited in claim 1, wherein said part execution server comprises access authorization means for determining whether or not said requests from said content page creation server will be received.

5. The distributed portal system recited in claim 1, wherein said content page creation server includes said part execution server.

6. The distributed portal system recited in claim 1, wherein said parts are Web programs for sending HTML text content by way of an Internet communication protocol.

7. The distributed portal system recited in claim 1, wherein said Internet communication protocol is the HTTP protocol.

8. A content page creation server comprising:
a content management system for managing one content page that is provided from one web site by dividing said content page into an arbitrary plurality of areas, disposing content separately in each of said plurality of areas in said content page, and further managing said content that is disposed in said areas by dividing said content into a plurality of blocks and disposing HTML text content or parts in said plurality of blocks;
a part content database for storing part content;
part execution means for entering and retrieving required part content from said part content database in response to requests, and for executing said parts; and
means for issuing part retrieval requests to said part execution means and retrieving content text for parts from said part database by way of an Internet communication protocol.

9. The content page creation server recited in claim 8, wherein said parts are Web programs for sending HTML text content by way of an Internet communication protocol.

10. The content page creation server recited in claim 8, wherein said Internet communication protocol is the HTTP protocol.

11. A computer readable recording medium storing a program that comprises:
a means for causing one or more computers to function as a first means for realizing a content management system for managing at least one content page that is provided from one website by dividing said content page into an arbitrary plurality of areas, disposing content separately in each of said plurality of areas in said content page, and further managing said content that is disposed in said areas by dividing said content into a plurality of blocks and disposing HTML text content or parts in said plurality of blocks;
one or more second means, which comprise a part content database for storing part content, for entering and retrieving required part content from said part content database in response to external requests, and for executing said parts; and
a third means, provided in said first means, for issuing part retrieval requests to said second means and retrieving content text for the parts from said second means by way of an Internet communication protocol.

12. A computer readable recording medium storing a program that causes a computer to function as a first means for realizing a content management system for managing at least one content page that is provided from one website by dividing said content page into an arbitrary plurality of areas, disposing content separately in each of said plurality of areas in said content page, and further managing said content that is disposed in said areas by dividing said content into a plurality of blocks and disposing HTML text content or parts in said plurality of blocks;
a second means for realizing a part content database for storing part content;
a third means for entering and retrieving required part content from said second means in response to requests and for executing said parts; and
a fourth means for issuing part retrieval requests to said third means and retrieving content text for the parts from said second means by way of an Internet communication protocol.
